(19) United States
(12) Patent Application Publication
(10) Pub. No.: US 2009/0139821 A1
(43) Pub. Date: Jun. 4, 2009

(54) Hydrodynamic torque converter and method for producing the same

(76) Inventors: Bernd Koppitz, Winterbach (DE); Rudolf Reinhardt, Esslingen (DE); Heinz Schultz, Hochdorf (DE); Bernhard Ziegler, Rechberghausen (DE)

Correspondence Address: KLAUS J. BACH, 4407 TWIN OAKS DRIVE, MURRYSVILLE, PA, 15668, US

(21) Appl. No.: 12/317,279

(22) Filed: Dec. 19, 2008

Related U.S. Application Data
(63) Continuation-in-part of application No. PCT/EP2007/004366, filed on May 16, 2007.

(30) Foreign Application Priority Data
Jun. 23, 2006 (DE) 10 2006 028 771.1

(51) Int. Cl. F16H 45/02; B23K 9/20

(52) U.S. Cl. 192/3.29; 29/889.2

(57) ABSTRACT

In a hydrodynamic torque converter having a turbine shell and a torsion damper spring carrier jointly mounted to a carrier part by way of rivets extending through aligned openings in the turbine shell and the spring carrier, rivets with rivet shanks and a rivet heads are inserted through the aligned openings and welded to the carrier part by pairs of electrodes by which the rivets are pressed into contact with the carrier part while a welding current is generated from one to the other of the pair of welding electrodes through the respective rivets and the carrier part.

This is a Continuation-In-Part Application of pending International patent application PCT/EP2007/004366 filed May 16, 2007 and claiming the priority of German patent application 10 2006 028 771.1 filed Jun. 23, 2006.

### BACKGROUND OF THE INVENTION

The invention relates to a hydrodynamic torque converter with a turbine shell connected jointly with a torsion damper support structure to a carrier part which is supported rotatably relative to the transmission input shaft hub and to a method for manufacturing such a hydrodynamic torque converter.

DE 19826351 C2 discloses a hydrodynamic torque converter with a torsion damper connected to a turbine shell.

Hot-riveting methods using hot rivets having rivet heads for interconnecting a torsion damper to a turbine shell are already known in principle from US 2005/0161442 A1, GB 3 1 528 730 and DE 31 40 368 A1.

It is the object of the present invention to provide a hydrodynamic torque converter and a method for manufacturing the same which makes it possible to attach the turbine shell of the torque converter after assembly of the torsion damper.

### SUMMARY OF THE INVENTION

In a hydrodynamic torque converter having a turbine shell and a torsion damper spring carrier jointly mounted to a carrier part by way of rivets extending through aligned openings in the turbine shell and the spring carrier, rivets with rivet shanks and a rivet heads are inserted through the aligned openings and welded to the carrier part by pairs of electrode by which the rivets are pressed into contact with the carrier part while a welding current flow is established from one to the other of the pair of welding electrodes through the respective rivets and the carrier part.

It is an important advantage of the invention, that it makes it possible to completely assemble the torsion damper, and optionally to test it for correct operation, and then to connect the turbine of the torque converter non-rotatably to the torsion damper from one side by hot riveting. For this purpose, the head of the hot rivet is provided on the axial side of the turbine whereas the narrow shank of the hot rivet is passed through an opening of the turbine shell and welded to a carrier part of the torsion damper. As a result of this assembly from one side, the turbine can be fastened to the torsion damper after the assembly of the torsion damper. A pre-assembly of turbine and torsion damper can prove complex and costly if the turbine is produced at a different production site from the torsion damper. In that case the turbine and the torsion damper would first have to be brought together at one site for assembly, and possibly then have to be transported to another site for assembly to the housing. This problem is aggravated if the individual components are produced by different manufacturers—in particular OEMs (Original Equipment Manufacturers) and other suppliers. By contrast, delivery of all components to a particular site, where the largest components are produced, provides for the lowest production/assembly cost.

With hot-riveting, a method as described in DE 102005006253.9-34, which is not a prior publication, is used especially advantageously. In addition to the advantage mentioned in the introduction, a further advantage of this method is that no deposits, which would be in the oil circuit of the hydrodynamic torque converter as soon as it was put into operation, is released. The oil circuit of the transmission, which usually has a common oil circuit with the hydrodynamic torque converter, is therefore kept clean. This is because, with hot-riveting, the deposits—i.e. the weld spatter—can be held back in a special catching area which may be in the form, for example, of an annular pocket or an inner end wall of a rivet hole.

As compared to the non-rotatable connection using a spline toothing, for example, a connection by hot-riveting has the advantage that it is a rigid connection without tooth flank play, so that noises resulting from resonance oscillations cannot occur.

The turbine shell can be hot-riveted directly to a sheet metal portion of the torsion damper, so that this sheet metal portion forms the carrier part mentioned. However, for reasons of weight and dynamics, a turbine is made of very thin sheet metal, which in turn makes a connection by the hot-riveting method problematic. For this reason a separate carrier, which may be configured, in particular, as an annular carrier, may be provided. In this case and the hot rivets are welded to the carrier. The sheet metal of the torsion damper and the thin turbine shell are therefore clamped between the carrier and the head of the hot rivet.

The carrier can be made sufficiently thick and stiff for it to absorb the forces required for welding and riveting. Furthermore, the carrier may have a centering function for the turbine and/or can function as a spring carrier of the torsion damper. In order to receive deposits, this carrier may include a blind hole. Because the carrier can be produced, in particular, as a turned part, an annular groove may also be provided for the circumferentially distributed hot rivets. The depth of the annular groove advantageously determines the length of the hot rivets. Thus, an especially long rivet may be provided, the shrinkage of which upon cooling is correspondingly high, so that a high tensile stress is also achieved. This high tensile stress provides for an especially good connection.

Especially advantageously, an embossment may be provided between the sheet metal parts to be connected by means of hot rivets, that is, the sheet metal of the torsion damper and of the turbine shell. Such an embossment forms an element preventing rotation between the sheet metal parts prior to riveting. This embossment may be provided, in particular, in the region of the hot rivets.

A support of the carrier part on the transmission input shaft hub 4 advantageously ensures proper axial positioning of the torsion damper with respect to the transmission input shaft hub by the carrier part.

Indirect welding of at least two rivets simultaneously ensures that the main current does not flow via reciprocally movable parts, so that secondary welding and/or surface damage cannot occur on those parts. Welding with at least two welding electrodes distributed uniformly over the circumference provide security against tilting.

The invention will become more readily apparent from the following description of exemplary embodiments thereof on the basis of the accompanying drawings.

### BRIEF DESCRIPTION OF THE DRAWINGS

FIG. 1 shows a hydrodynamic torque converter 1 in a half-section with a torque converter turbine wheel mounted by hot rivets,

FIG. 2 to FIG. 4 show, in a detail of the hydrodynamic torque converter according to FIG. 1, a production method for the connection by hot riveting of the turbine shell,

FIG. 5 shows a hot rivet with a conical geometry in an alternative configuration,

FIG. 6 shows a clamping of a constructional unit of the hydrodynamic torque converter on a hot-riveting machine, and

FIG. 7 and FIG. 8 show, analogously to FIG. 2 to FIG. 4, the process steps for hot-riveting such an alternative hot rivet.

### DESCRIPTION OF EXEMPLARY EMBODIMENTS

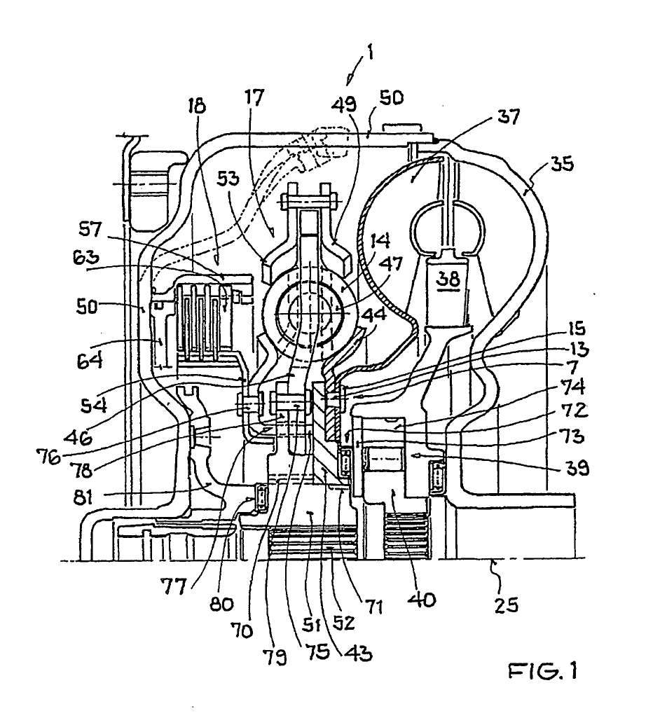

FIG. 1 shows a hydrodynamic torque converter 1 in a half-section. This hydrodynamic torque converter 1 is connected on the input side by a screw connection to a partially flexible drive plate (not shown in detail) and to a crankshaft of a drive engine. Two alternative possibilities for the screw connection are illustrated in the drawing.

On the output side, the hydrodynamic torque converter 1 is connected via a spline toothing 52 to a coaxially arranged transmission input shaft (not shown in detail) of a transmission. The transmission input shaft, the hydrodynamic torque converter 1 and a crankshaft flange are arranged coaxially with a central axis 25.

The hydrodynamic torque converter 1 comprises the housing 50, a pump shell 35, a turbine 37 and a stator 38. The following detailed description of an exemplary embodiment follows the power flow from the crankshaft to the housing 50. From the housing 50 the power flow passes to the pump shell 35. With hydrodynamic power transmission the power flow is transmitted from this pump shell 35 to the turbine 37 and, via a torsion damper 17, to the transmission input shaft mentioned. By contrast, with a lock-up clutch 18 engaged, the power flow is transmitted from the housing 50 via the lock-up clutch 18 to the torsion damper 17 and then to the transmission input shaft.

The turbine 37 is arranged beside the pump shell 35 on the side of the latter oriented towards the drive engine. The stator 38, which is supported in the conventional manner on a freewheel 39, is arranged radially inside and axially between the pump shell 35 and the turbine 37.

An inner hub 40 of the freewheel 39 is connected non-rotatably to a stator shaft (not shown in detail) by means of an internal toothing.

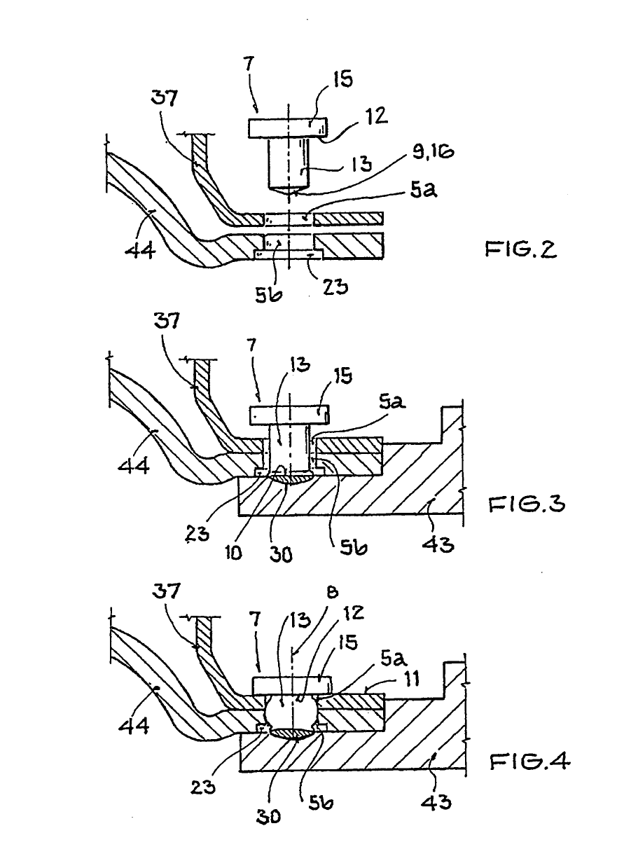

The turbine 37 has in its radially inner region a plurality of circular openings 5a, which can be seen in more detail in FIG. 2 to FIG. 4, distributed evenly on the circumference. Hot rivets 7, comprising a head 15 and a shank 13, are inserted in these openings 5a from the side of the turbine 37. The hot rivets 7 clamp a spring carrier 44 against an annular carrier 43. The establishment of this connection is explained in more detail below in FIG. 2 to FIG. 4. The spring carrier 44 is arranged with limited rotatability against the torsional stiffness of the torsion damper 17 with respect to a sheet metal support 46. For this purpose, curved coil springs 47, 14 of the torsion damper 17 are received in recesses worked into the sheet metal of

the sheet-metal support 46,

the spring carrier 44 and

a sheet-metal coupling element 53 riveted non-rotatably to the spring carrier 44.

The sheet-metal support 46 is provided, radially outside the curved springs 47, 14 in the circumferential direction, with curved attachment pieces 49 which guide the bow springs 14. The sheet-metal support 46 is connected non-rotatably by its radially inner portion to a transmission input shaft hub 51. This transmission input shaft hub 51 is connected non-rotatably to the transmission input shaft by means of the spline toothing 52 mentioned previously. The carrier 43 is supported radially and axially on the transmission input shaft hub 51 by means of a slide bearing. A lubricant channel 70 is provided for lubricating the axial pairing of slide surfaces. This lubricant channel 70 opens into a lubricant channel 71 which is provided for lubricating the radial pairing of sliding surfaces. At the same time the lubricant channel 70 ensures the lubricant circulation of the converter cooling circuit. The carrier part 43 is supported axially on an axial securing ring 73 via an axial roller bearing 72. The axial securing ring 73 is in turn supported axially on an outer race 74—i.e. clamping ring—of the freewheel 39.

The sheet-metal coupling element 53 is connected immovably to an inner disk carrier 54. The inner disk carrier 54 secures inner clutch disks of the lock-up clutch 18 by means of an axial toothing. These clutch disks are displaceable non-rotatably and axially with respect to the inner disk carrier 54. Likewise, outer clutch disks are secured non-rotatably and axially displaceably to an outer disk carrier 57 rigidly connected to the housing 50. For this purpose, an axially-oriented internal toothing, in which an external toothing of the outer clutch disks engages, is worked into the outer disk carrier 57. The outer disk carrier 57 extends coaxially to the housing 50 and is friction-welded immovably thereto. The outer and inner clutch disks engage in one another radially. The inner clutch disks 55 have friction linings which are fastened firmly to a base body on both sides. These friction linings are located on both sides of the outer clutch disks and on one side of the front clutch disk and on a bracing disk 63. A friction moment is transmitted by the contact surfaces. A piston 64 is provided in order to disengage and engage the lock-up clutch 18.

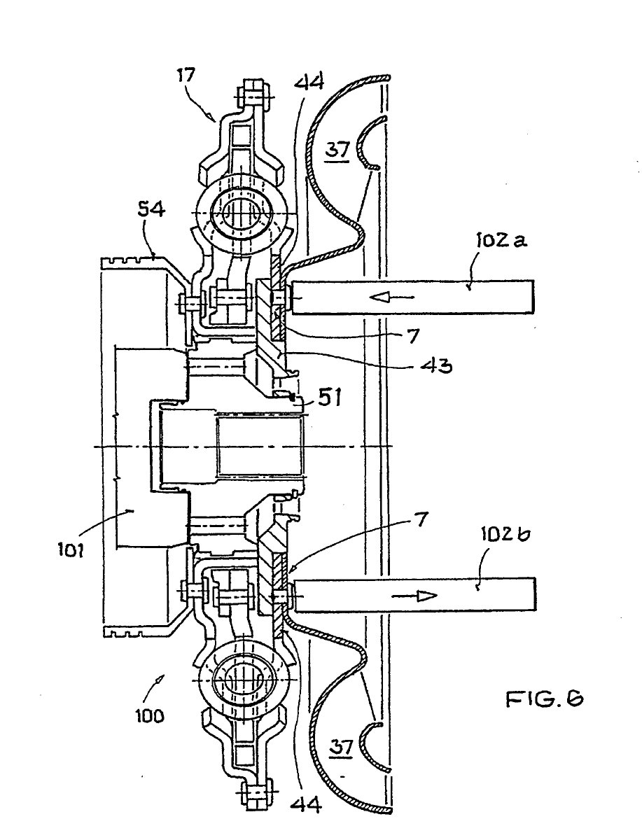

In the production process described below with reference to FIG. 2 to FIG. 4, a pressure is applied to the hot rivet 7 from the side of the transmission—that is, from the right in the drawing plane—in order to weld the hot rivet 7 to the annular carrier 43 and then to upset the hot rivet 7. For this purpose, as shown in FIG. 6, an assembly unit 100 is first assembled, comprising

the inner disk carrier 54,

the torsion damper 17,

the annular carrier 43 and

the transmission input shaft hub 51.

The transmission input shaft hub 51 is placed in a receptacle 101 of a machine and the turbine wheel or shell 37 together with the hot rivets 7 is placed in the constructional unit 100. The hot-riveting process, as illustrated in detail with reference to a single hot rivet in FIG. 2 to FIG. 4, is then carried out by means of at least two electrodes 102a, 102b distributed uniformly on the circumference. The forces for pressing in the hot rivets 7 are taken up by the receptacle 101 via the carrier 43 and the transmission input shaft hub 51. As indicated by the arrows in FIG. 9, welding is carried out indirectly. In this case the welding current flows through one electrode 102a into another electrode 102b. The main current therefore flows relatively directly via the hot rivets 7, the carrier 43 and the transmission input shaft hub 51. This ensures that parts in contact with one another—but movable with respect to one another—are not welded together or do not adhere to one another, and the surfaces of these components are protected.

FIG. 2 to FIG. 4 show, in a detail of the hydrodynamic torque converter 1 according to FIG. 1, the method for producing the joint in the region of the hot rivet 7. As compared to FIG. 1, the detail is shown rotated through 90°.

FIG. 2 shows the turbine wheel 37 and the spring carrier 44 which are to be fastened to the annular carrier 43 (not shown in FIG. 2). The turbine wheel 37 and the spring carrier 44 have circular through-openings 5a, 5b. The hot rivet 7 with the shank 13 and the head 15 is also shown. The openings 5a, 5b have a larger diameter than the shank 13, so that in the assembly position the hot rivet 7 has play with respect to the openings 5a, 5b. In this exemplary embodiment the end face 9 of the hot rivet 7 oriented away from the head 15 is configured with a tip 16. The hot rivet 7 consists, for example, of a steel with a low carbon content, in order to ensure high toughness. The opening 5b in the spring carrier 44 is provided on the side thereof oriented away from the head 15 with a step which enlarges the opening 5b on this side in the catching area 23. The function of this catching area 23 is described below. In this exemplary embodiment the catching area 23 is cylindrical and can be described as an annular pocket. However, the catching area 23 may also have a different geometry.

FIG. 3 shows additionally the annular carrier 43 to which the turbine 37 and the spring carrier 44 are to be fastened non-detachably by means of the hot rivet 7. For this purpose, the hot rivet is first inserted in the openings 5a, 5b with the aid of a welding electrode (not shown here), to which the head 15 of the hot rivet 7 is connected firmly but detachably. This connection of the head 15 to the welding electrode is produced, for example, by a vacuum. Alternatively, the head 15 may be connected to the welding electrode by mechanical clamping. Alternatively, the hot rivet may already be fitted in the opening 5a or 5b, so that the position of turbine 37 with respect to spring carrier 44 is defined.

The end face 9 of the hot rivet 7 is then welded to the surface 10 of the carrier 43. This is done here by a resistance welding process, for example. All electric welding methods are, however, suitable. As the resistance welding process, a projection welding process, in particular, is used here. For this purpose the end face 9 of the hot rivet 7 is formed appropriately as the tip 16. The welding is effected by an electrical welding pulse. In this exemplary embodiment the pulse has a length in the order of magnitude of 30-60 milliseconds, a usual value when resistance-welding the end faces of hot rivets 7. FIG. 3 also shows the welding zone 30 now produced. An arc stud welding process, for example, is an alternative to electric resistance welding. It is, however, less suitable here, since the arc would jump to the other side with this method, which is undesirable.

FIG. 4 shows the non-detachable connection of the carrier 43 to the turbine 37 and the spring carrier 44 after the next and last process step has been carried out. In this step the hot rivet 7 is deformed plastically. This plastic deformation is produced by applying a second electrical pulse which follows the first welding pulse after a short time interval. This second pulse has a lower current strength and is significantly longer than the first welding pulse. It may last, for example, 1000 milliseconds. The hot rivet 7 is heated and softened by the second pulse.

At the same time a force which leads to a plastic deformation in the form of an upsetting of the shank 13 of the hot rivet 7 is exerted in the longitudinal direction 8 of the hot rivet 7. The upsetting force may have the same value as the welding force, or may be lower or higher than the welding force. This upsetting movement is carried out until at least a portion of the underside 12 of the head 15 of the hot rivet 7 rests against the surface 11 of the turbine 37. The material of the shank 13 forced to the sides during upsetting now completely fills the openings 5a, 5b zonally in the circumferential direction. The weld spatter produced during welding of the end face 9 of the hot rivet 7 to the surface 10 of the carrier part 43, as well as material displaced in this catching area during upsetting, is received in the catching area 23 of the opening 5b, so that a clean, smooth contact surface is present both

between the carrier 43 and the spring carrier 44, and

between the spring carrier 44 and the turbine 37.

The weld spatter cannot therefore enter the oil circuit of the hydrodynamic torque converter, or possibly of the transmission, as scale loss.

An electric welding circuit is established via two rivets as shown in FIG. 6 by the two electrodes (102a, 102b) so that welding current flows via one electrode (102a) through one rivet into the carrier 43 and through the carrier 43 and the other rivet to the other electrode (102b).

Because, according to this method, a welded connection is produced only between the hot rivet 7 and the carrier 43, it is possible to fasten the spring carrier 44 and the turbine 37, which do not need to be weldable, to the carrier 43. For example, the spring carrier 44 and the turbine 37 may be components made of aluminum, surface-coated steel—in particular nitrated steel—ceramics or plastics, in particular fiber-reinforced plastics—as well as composites of such components. Only the hot rivet 7 and the carrier part 43 must be made of a weldable material.

Furthermore, by virtue of the fact that the hot rivet 7 has clearance with respect to the bore 5 prior to the implementation of the method, the end face 9 of the hot rivet 7 can be welded to the carrier 43 without a short circuit even when connecting electrically conductive materials for the carrier 43, since the welding current is conducted only through the hot rivet 7 itself. In all cases the high electrical resistance needed for welding occurs between the end face 9 of the hot rivet 7 and the surface 10 of the carrier 43.

After implementation of the method, the hot rivet 7 shrinks because of the preceding thermal reshaping. In this way, additional clamping of the joint is obtained, resulting in high strength of the connection.

Furthermore, the welding and subsequent plastic deformation take place in one work cycle on a standard welding press, without the requirement for additional retooling or resetting.

Hardening of the weld zone 30 possibly occurring after the welding is reduced by the subsequent heating in connection with the plastic deformation.

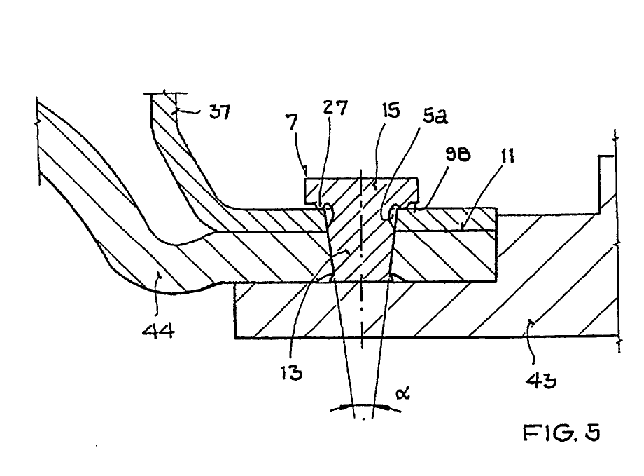

Apart from the cylindrical geometry of the opening 5b described above, it is possible to provide a conical geometry, as represented in FIG. 5. A conical opening is simpler to produce than a cylindrical one when using a casting as the spring carrier 44 or the turbine 37, for example. The diameter of the opening increases with increasing distance from the carrier 43. The cone angle α may vary; in this example it is approximately α=25°. It can be seen that the material displaced during upsetting of the shank 13 presses against the wall of the openings in the spring carrier 44 and thus fills these openings almost completely. In addition, in this exemplary embodiment a peripheral sealing ring 27 is formed integrally on the underside 98 of the head 15 of the hot rivet 7. After the upsetting process, the sealing ring 27 bears against the surface 11 of the spring carrier 44 and additionally seals the joint. Alternatively, a similar peripheral sealing ring which performs the same function may be provided on the surface 11 of the spring carrier 44.

For installation, the rivet is preferably attached to the welding electrode (102a, 102b) for example, by vacuum. However, the rivet may also be attached to the welding electrode magnetically or mechanically.

The openings in the turbine shell 37 may be punched or drilled.

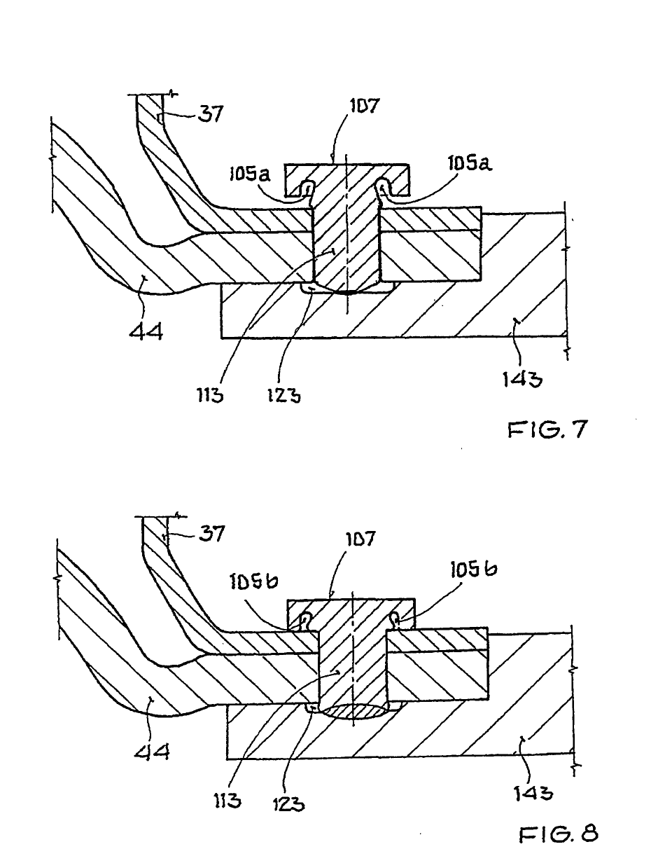

In FIG. 2 to FIG. 4 the openings 5a, 5b are shown with an exaggerated diameter for greater clarity. In practice, the stud 13 has a very small clearance in the openings 5a, 5b, so that centering for the subsequent welding is achieved. Given this small clearance, in order to create a receptacle for the material discharged between head and turbine during the riveting process, a configuration as shown in FIG. 7 and FIG. 8 may be provided.

FIG. 7 and FIG. 8 show a rivet 113 with an annular groove (105a, 105b) on the underside of the head 107 in two process steps. This annular groove receives material discharged during riveting of the turbine 37. With this configuration in conjunction with small radial play, a very high radial bracing force is produced between the stud 113 and the turbine 37 and the spring carrier 44. It is noted that, in addition to providing a force-locking connection, shear forces can also be transmitted by the rivet 107.

The catching area 123 for receiving the weld spatter is configured differently in this case than as shown in FIG. 2 to FIG. 4. Thus, the catching area 123 according to FIG. 7 and FIG. 8 is a depression in the annular carrier 143. This depression may be in the form of a shallow blind hole. Because the carrier 143 is a turned part, however, the depression may also be in the form of an annular groove which is produced in one work cycle when turning the carrier 143.

The embodiments described are only exemplary configurations. A combination of the features described for different embodiments is also possible. Further features of the device parts, which form part of the invention, are apparent from the geometries of the device parts shown in the drawings.

What is claimed is:

1. A hydrodynamic torque converter having a pump shell (35), a carrier part (43) supported on a transmission input shaft hub (51), a torsion damper (17) also supported on the transmission input shaft hub (51) and including a spring carrier structure (44) connected to the carrier part (43), a turbine shell (37) disposed opposite the pump shell (35) and being also supported by the carrier part (43), the turbine shell (37) and the spring carrier structure (44) having aligned openings (50, 56) and being jointly connected to the carrier part (43) by hot rivets (7) having heads (15) and shank ends (13, 113) extending through the aligned openings (50, 56) of the turbine shell (37) and the spring carrier (44), the shank ends (13, 113) of the rivets (7) being but-welded to the carrier part (43) and the heads (15) engaging the turbine shell (37) and firmly holding the turbine shell (37) together with the spring carrier (44) mounted to the carrier part (43).

2. The hydrodynamic torque converter as claimed in claim 1, wherein the torque converter includes a stator (38) arranged between the pump shell (35) and the turbine shell (37) and an axial roller bearing (72) is arranged between the stator (38) and the carrier part (43).

3. The hydrodynamic torque converter as claimed in claim 1, wherein an annular groove (105a) is provided at the underside of the rivet head (15) around the shank end (13, 113) for receiving material formed during the attachment of the rivet (13, 113).

4. The hydrodynamic torque converter as claimed in claim 1, wherein a recess is formed in one of the carrier part (43) and the spring carrier structure (44) around the shank end (13, 113) of the rivet (7, 107) so as to form a catching areas (23, 123) for receiving weld spatter.

5. The hydrodynamic torque converter as claimed in claim 1, wherein the openings (5a, 5b) have a larger diameter than the rivet shank to permit radial expansion of the rivet shank into contact with the walls of the openings (50, 56) during upsetting of the rivets after they have been welded to the carrier part (43).

6. A method for producing a hydrodynamic torque converter having a pump shell (35), a turbine shell (37) disposed adjacent the pump shell (35) and supported on a carrier part (43) disposed on an input shaft hub (51), and a torsion damper including a spring carrier structure (44) also supported on the carrier part (43) and the turbine shell (37) having aligned openings for jointly mounting them to the carrier part (43), the method of mounting comprising the following steps: placing the spring carrier structure (44) and the turbine shell (37) with the openings aligned onto carrier part (43), inserting rivets (7) provided with heads (15) and shanks (13) through the openings and pressing pairs of rivets with electrodes (102a, 102b) onto the carrier part (43), and establishing a current flow through the pairs rivets and the carrier part (43) from one electrode (102a) to an other electrode (102b) so that the rivets are welded to the carrier part (43) and upsetting the rivets until the underside (12, 98) of the rivet heads (15) rest on the turbine shell (37) and firmly engage the turbine shell (37) and the spring carrier structure (44) with the carrier part (44).

7. A method for producing a hydrodynamic torque converter as claimed in claim 6, wherein, after being electrically welded to the surface (10) of the carrier part (43), the shank (13) of the hot rivet (7) is upset so that the rivet shank (13) is radially expanded into a firm contact with the walls of the openings (5a, 5b).

8. The method as claimed in claim 7, wherein the shank (13) of the rivet (7) is heated by a second electrical pulse applied a short time interval after the welding of the end face (9) and is simultaneously upset.
